(19) United States
(12) Patent Application Publication
(10) Pub. No.: US 2025/0272241 A1
(43) Pub. Date: Aug. 28, 2025

(54) PREFETCH TABLE STORAGE CIRCUITRY

(71) Applicant: Arm Limited, Cambridge (GB)

(72) Inventors: Devin S. Lafford, Austin, TX (US); Alexander Cole Shulyak, Austin, TX (US)

(21) Appl. No.: 18/590,726

(22) Filed: Feb. 28, 2024

(51) Int. Cl. G06F 12/0862

(52) U.S. Cl. CPC G06F 12/0862

(57) ABSTRACT

Briefly, example apparatuses, articles of manufacture, and/or techniques are disclosed that may be implemented, in whole or in part, to implement, facilitate and/or support prefetching by a computing element, such as, prefetch table storage circuitry to store stream distance indicators corresponding to memory address regions.

### FIELD

The present disclosure relates generally to data processing, and more particularly, data prefetching.

### BACKGROUND

Data processing circuitry may include prefetching circuitry. Prefetching is a process of retrieving information such as data and/or instructions prior a demand request requiring the information. Prefetching may include predicting which memory locations may be subject to future demand requests based on training information such as, for example, preceding demand requests.

### SUMMARY

At least some examples of the present technique provide an apparatus comprising:
prefetch table storage circuitry to store a prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

At least some further examples of the present technique provide computer-readable medium storing computer-readable code for the fabrication of an apparatus as set out above.

At least some further examples of the present technique provide a method comprising:
storing a prefetch table, the prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 illustrates an example apparatus including a processing element and prefetch circuitry in accordance with an implementation;

FIGS. 2A-B illustrates example prefetch table storage circuitry in accordance with an implementation;

FIG. 3 illustrates further example prefetch table storage circuitry in accordance with an implementation;

FIGS. 4A-4F illustrate various example prefetch tables associated with various example scenarios, in accordance with an implementation;

FIG. 5 illustrates an example method of maintaining a prefetch table in accordance with an implementation.

FIG. 6A illustrates an example of an apparatus comprising a processing element (e.g. a CPU or GPU) comprising execution circuitry for executing processing operations in response to decoded program instructions, in accordance with an implementation;

FIG. 6B illustrates an example of a vector datapath that may be provided as part of the execution circuitry of the processing element illustrated in FIG. 5A, and vector registers for storing vector operands for processing by the vector datapath, in accordance with an implementation; and

FIG. 7 illustrates an example computer-readable medium storing computer-readable code for the fabrication of an apparatus, in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Out-of-order execution allows processing circuitry to make use of instruction cycle that might otherwise be unused. Additionally, execution pipelining and increasing core widths may allow processing circuitry to complete multiple demand loads in a single instruction cycle. These factors may present challenges to prefetching data. For example, OoO execution may disrupt the data access patterns used to trigger prefetch requests by executing demand load instructions in a different order than that requested by the program instructions. As another example, prefetch circuitry may track demand loads to identify data access patterns. In some cases, the prefetch circuitry may process fewer loads in a cycle than are issued by corresponding processing circuitry. A prefetch table, such as a training buffer, may be used to buffer load data to accommodate this disparity. During operation such a buffer may fill and overflow, resulting in evictions from the table. In some cases, this may prevent such prefetching circuitry from accumulating sufficient data to identify certain data access patterns, such as streaming access patterns. In further cases, this may result in data addresses that are part of a single streaming pattern to be detected as parts of multiple streaming patterns. For instance, if a buffer entry corresponding to the middle of a data stream is evicted, buffer entries for the head and tail of the stream may be detected as parts of separate streams.

As discussed further below, implementations of the described technology may address these and/or other challenges via a prefetch table that includes a stream distance indicator having more than two states. For example, as discussed below, a prefetch table entry corresponding to a memory address region may include an indicator of the region inclusion in a streaming data pattern by indicating its distance to a root entry corresponding to a stream root memory address region. In some cases, the distance indicator may remain after the root entry or other entries in the stream are evicted from the table. Accordingly, membership in a streaming pattern remains detectable even if other members of the streaming pattern are evicted from the prefetch table. Further implementations may address such challenges via stream direction indicators stored in a prefetch table in addition to stream distance indicators. For example, stream direction indicators may prevent a lower-addressed memory region from being associated with an ascending streaming pattern.

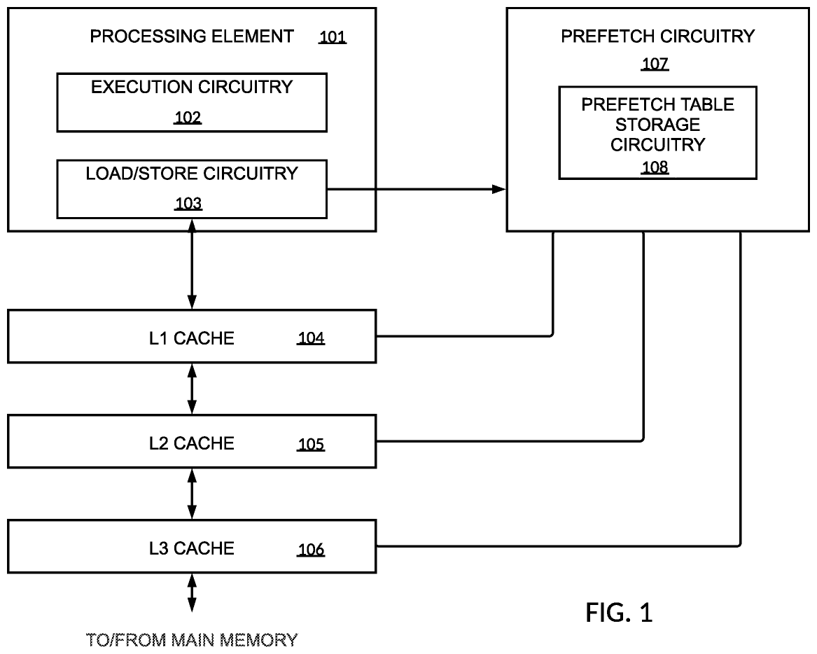

FIG. 1 illustrates an apparatus including a processing element 101 and prefetch circuitry 107 in accordance with an implementation. For example, the processing element 101 may comprise a central processing unit (CPU), a graphics processing unit (GPU), and/or the like.

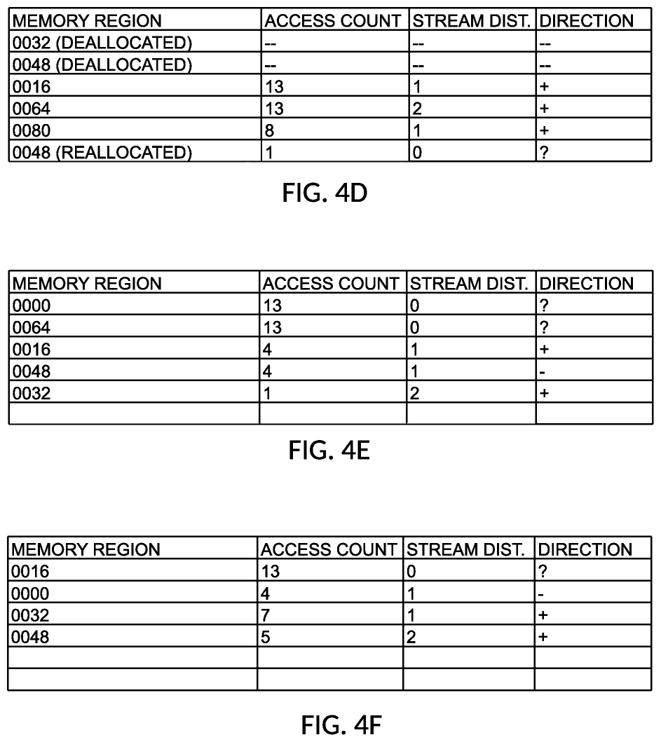

In this example, the processing element 101 may include execution circuitry 102 to execute program instructions on data retrieved from memory. For instance, the execution circuitry may include various functional execution units, such as an arithmetic/logic unit (ALU), a floating point unit (FPU), a vector processing unit (VPU), and/or the like. As an example, the execution circuitry 102 may be an implementation of execution circuitry 501 as described with respect to FIGS. 5A-B. The processing element 101 may further include load/store circuitry 103. The load/store circuitry 103 may execute load instructions to issue load requests (“demand load requests”) to load data from memory as operands for the program instructions executed by the execution circuitry 102. Similarly, the load/store circuitry 103 may execute store instructions to issue store requests (“demand store requests”) to store data to memory.

In various implementations, the processing element 101 may include further circuitry to support data processing operations. For instance, processing element 101 may include fetch circuitry to retrieve program instructions, decode circuitry to decode the retrieved instructions, and instruction issue circuitry to issue instructions to execution circuitry 102. Further implementations may include further processing circuitry, such as branch prediction circuitry, out-of-order (OoO) execution circuitry, memory management circuitry, and/or the like. For instance, branch prediction circuitry may predict outcomes of branch program instructions to enable processing element 101 to fetch instructions that may conditionally be executed subsequent to the branch program instructions. OoO execution circuitry may include various circuitry to support OoO execution, such as instruction buffers/queues, instruction dispatch circuitry, register renaming circuitry, instruction retirement circuitry and/or the like. Memory management circuitry may include address translation circuitry to translate between a virtual address space used by processes executed by the processing element 101 and a physical address space used by the memory system to address particular storage units of main memory, registers of memory-mapped input/output (I/O) devices, and/or the like.

The illustrated example further comprises a memory system including a plurality of caches 104, 105, 106 disposed in a cache hierarchy providing an intermediary between the processing element 101 and main memory. In this example, a first level (1) cache 104 may receive demand requests from load/store circuitry 103 and comprises storage circuitry to store data and/or instructions accordingly. The illustrated L2 cache 105 comprises storage circuitry to cache data and/or instructions for retrieval into the L1 cache 104. Similarly, the illustrated L3 cache comprises storage circuitry to store data and/or instruction for retrieval into the L2 cache 105. In some implementations, the caches 104, 105, 106 may store data in groups of contiguously addressed memory locations termed cache-lines. For instance, a particular implementation might utilize 64 byte, 32 byte, or 128 byte cache-lines.

For example, to service a demand load instruction for certain addressed data, the processing element 101 may attempt to retrieve the addressed data from the L1 cache 104. If the addressed data is present in the L1 cache 104 (e.g., there is a “cache hit” in the L1 cache 104), then the data is retrieved from the L1 cache 104. If the addressed data is not in the L1 cache 104 (e.g., there is a “cache miss” in the L1 cache 104), then a command is issued to retrieve the data from the L2 cache 105. Similarly, if there is a hit in the L2 cache 105 then the requested data is sent to the L1 cache 104, while if there is an L2 cache miss a request for the data is issued to the L3 cache 106. Likewise, the L3 data request may trigger a cache hit if a copy of the data is stored in the cache 106 or the request may trigger a request to retrieve the data from main memory in case of a cache miss.

Different implementations may comprise various different cache architectures and may execute various cache protocols. For instance, there may be fewer caches (e.g., the L2 cache 105 may be the last level cache), there may be more caches (e.g., a fourth level (L4) cache may be the last level cache), certain caches may be private to the processing element 101 while others are shared between multiple processing elements, and/or other like variations. As another example, a data processing apparatus may comprise separate data and instruction caches (e.g., at the L1 cache level). In some implementations, the caches have hierarchal speeds and sizes, where the L1 cache is smaller and faster than the L2 cache, which is smaller and faster than the L3 cache.

The illustrated example further comprises prefetch circuitry 107. The prefetch circuitry 107 may comprise circuitry to predict data that may be needed for a future instruction and to speculatively load that data into a cache 104, 105, 106. In particular, the prefetch circuitry 107 may be coupled to one or more caches 104, 105, 106 to issue prefetch requests. In contrast to demand requests issued by the load/store circuitry 103 with respect to a particular instruction to be executed, prefetch requests issued by the prefetch circuitry 107 load data in anticipation of possible future instruction executions. In the illustrated example, the prefetch circuitry 107 may be coupled to the L2 cache 105 to issue L1 cache prefetch requests. An L1 cache prefetch request may include information identifying target prefetch data addresses to be loaded into the L1 cache 104 by the L2 cache 105 (e.g., from data already stored in the L2 cache 105 or data retrieved from the L3 cache 106). Similarly, the prefetch circuitry 107 may be coupled to the L3 cache 106 to issue L2 cache prefetch requests for the L3 cache 106 to load data at requested prefetch target addresses into the L2 cache. Other implementations may include various other configurations; for instance, the prefetch circuitry 107 might be coupled to a main memory interface to issue L3 prefetch requests, the prefetch circuitry 107 might be coupled to only one of the caches 104, 105, 106, the prefetch circuitry 107 may issue prefetch L1 prefetch requests to the L1 cache and L2 requests to the L2 cache and/or other like configurations.

The example prefetch circuitry 107 may include circuitry to detect a data access pattern, such as a stream data access pattern. A stream data access pattern may occur when demand requests are issued for data found in a sequence of memory address regions. In some implementations, the memory address regions may be virtual address memory pages and/or groups of memory pages. For instance, the memory address regions may be 4 KiB-sized memory regions. In other implementations, the memory address regions may have other configurations. For example, the memory address regions may be physical memory address regions, the memory address regions may have larger or smaller sizes (such as, e.g., 512 bytes, 8 KiB, or other applicable sizes). As another example, the memory address regions may be sized differently based on whether the data access pattern will be used to trigger L1 or L2 prefetch requests.

The prefetch circuitry 107 may include prefetch table storage circuitry 108. The prefetch table storage circuitry 108 may store a prefetch table to assist with various prefetch related operations. For example, the circuitry 108 may comprise circuitry to track demand accesses to memory address regions to identify streaming access patterns. In some implementations, the memory address regions may encompass a plurality of cache-line addresses. For instance, the memory address regions may encompass 1 KiB, 2 KiB, 4 KiB, 8 KiB, or similarly sized regions. For example, the memory address regions may have a granularity corresponding to a virtual memory page size used by processing element 101, such as, for instance, single page-sized regions, multiple page-sized regions, or partial page-sized regions (e.g., ½ page sized regions). As another example, the memory address regions might be unrelated to the system virtual address page size. For instance, the address region size may be a configurable system parameter, via configuration registers or other programmable system parameters. In some implementations, the memory address region size may be set according to factors such as the time/number of accesses needed to reach an threshold, the degree of OoO behavior of the system, and/or the like. For instance, relatively more demand loads may be expected to fall within a relatively larger memory access region, while relatively smaller memory access regions may be relatively less impacted by OoO behavior.

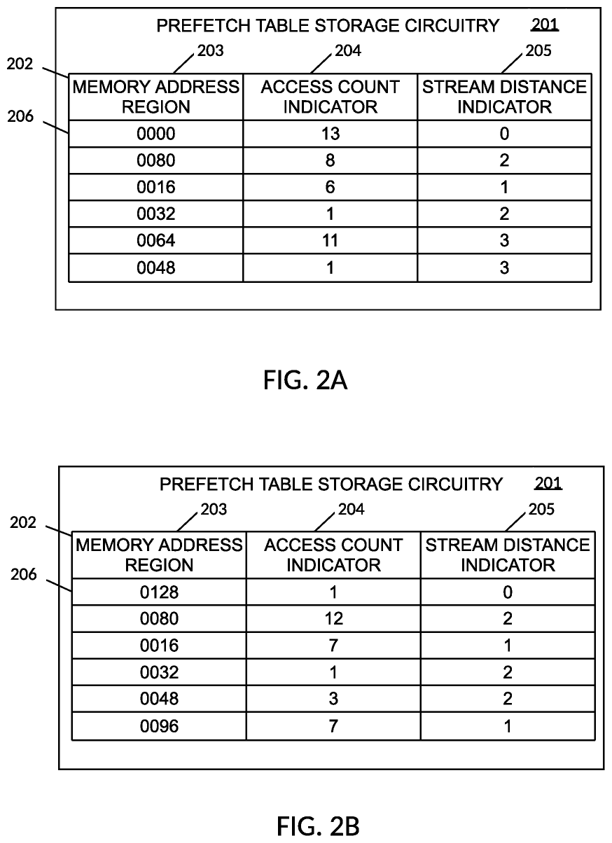

In further implementations, the prefetch table storage circuitry 108 may include circuitry to store additional prefetch tables. For example, the storage circuitry 108 may store tables at different address granularity. For instance, the circuitry 108 may store one or more cache-line—granularity tables. For example, the circuitry 108 may store a pattern history table (PHT) with entries corresponding to individual cache-lines and including information related to data accesses involving that cache-line, such as common offsets to other accessed cache-lines, cache miss/hit tracking information, and/or the like. In some such implementations, the first prefetch table (at the memory address region granularity) may be a training table used to populate the second prefetch table (at the cache-line granularity). In further implementations, the region-granularity prefetch table may be used to generate certain prefetch request types while the cache-line—granularity prefetch table may be used to generate other prefetch request types. For instance, the region-granularity prefetch table may be used to generate stream-type prefetch requests to prefetch multiple cache-lines while the cache-line granularity table may be used to generate stride-type prefetch requests to prefetch individual cache-lines. In still further implementations, the region-granularity prefetch table may be dedicated to detecting stream access patterns. Accordingly, various information may be stored by the prefetch table circuitry 108 according to different prefetch technique implementations. FIGS. 2A-B illustrate an example prefetch table in different states according to various detected demand memory accesses.

FIG. 2A illustrates an example of a prefetch table 202 stored by prefetch table storage circuitry 201, according to an implementation. For example, the prefetch table storage circuitry 201 may be an implementation of prefetch table storage circuitry 108 of FIG. 1. For ease of explanation, table values are illustrated in decimal notation. In practice, the prefetch table storage circuitry 201 may comprise various data storage elements having possible states indicative of corresponding table values. For instance, the prefetch table storage circuitry 201 may comprise circuitry such as transistors configured as binary memory cells to store states associated with a logical ‘1’ and a logical ‘0’, such as, for example, static random memory access (SRAM) cells and/or content addressable memory (CAM) cells. As another example, the prefetch table storage circuitry 201 may comprise multilevel storage elements having more than two possible states, for instance, double-level memory cells able to store two bits in each cell (e.g., 4 different states). In some implementations, the prefetch table storage circuitry 201 updates the prefetch table 202 responsive to memory accesses (e.g., a demand load to a cache-line falling in address region X triggers the allocation or update of an entry corresponding to address region X).

The example prefetch table 202 comprises entries corresponding to memory address regions 203. In the illustrated example, the memory address regions are indicated by the initial address of the memory address region with leading zeros to differentiate from figure reference numbers. Unless otherwise indicated, memory addresses are at the cache-line granularity (e.g., memory region 0001 refers to the address region that is one cache-line away from address region 0000). For example, the entry corresponding to memory address region 0000 (e.g., “entry 0000”) corresponds to 16 contiguously addressed cache-lines with virtual addresses 0000-0015 representing the virtual addresses of the 16 cache-lines. As discussed above, the memory address regions 203 may comprise virtual memory address regions, physical memory address regions, and/or combinations thereof. As an example, prefetch table storage circuitry 201 may comprise a first table indexed by virtual address and a second table indexed by physical addresses. For instance, in this example, the first table may be used to generate L1 prefetch requests while the second table may be used to generate L3 and/or L2 prefetch requests. Additionally, for ease of explanation, the memory address regions each comprise four cache-line addresses. As discussed above, in implementations, the memory address regions may comprise any suitably sized address regions, such as for example, memory page-sized regions. In the illustrated example, the entries 206 include memory address region indicators as fields in the table. In other examples, the storage circuitry 201 may associate the memory address regions with table entries 206 in other manners. For instance, the prefetch table may be associated with a directory mapping memory address regions to table entries. In this example, the prefetch table storage circuitry 201 may perform a directory lookup operation in response to a demand load that will be used to update the table 202.

The entries 206 of the example prefetch table 202 further comprise access count indicators indicative of numbers of access to corresponding memory address regions. In some implementations, the access count indicators are indicative of a number of demand accesses issued by processing circuitry such as load/store circuitry (e.g., load/store circuitry 103. In various implementations, the access count indicators 204 may correspond to certain types of accesses, such as demand loads or particular types of demand load instructions. In other implementations, the access count indicators 204 may track general demand load instructions and/or may be configurable to track selected access types. In some cases, the access count indicators are indicative of a number of subregions within a memory address region to which there has been at least one access. A subregion, in some examples, may correspond to a cache-line. In some cases, the access count indicators count accesses to cache-lines having addresses falling within the corresponding memory address region. For example, entry 0000 of FIG. 2A has an access counter indicative of 13 accesses to the memory address region from 0000-0015. For instance, the 13 accesses might have resulted from 6 accesses to cache-line 0000, 2 accesses to cache-line 0001, and 5 accesses to cache-line 0014. In further cases, the access count indicators count unique accesses to cache-lines falling within the corresponding memory address region. For instance, in the previous example of entry 0000, the 13 accesses may have resulted from accesses to 13 unique cache-lines having addresses between 0000-0015 (i.e. there has been at least one access to memory addresses corresponding to 13 different cache-lines). In other words, the access count indicator is indicative of the number of different cache-lines associated with the memory region which have been accessed. In these cases, multiple accesses to a particular cache-line may be ignored and/or otherwise uncounted by the prefetch table storage circuitry 201. With reference to the example above, in which 6 accesses to cache-line 0000 are made, 2 accesses to cache-line 0001 are made, and 5 accesses to cache-line 0014 are made, the access count indicator would indicate a count of 3.

The entries 206 of the example prefetch table 202 may further comprise stream distance indicators 205 indicative of a stream distance between the entry's address region and a root memory address region. For example, the stream distance indicators 205 may be indicative of a number of contiguous memory regions from a root memory address region to the corresponding entry. In some implementations, a first memory address region is adjacent to a second memory address region when the second memory address region begins with the first address following the last address of the first region, or vice versa.

The root memory address region may correspond to an entry having an access count indicator 204 indicating a number of access meeting a stream root detection threshold. In various implementations, the stream root detection threshold may be configured in various manners. As examples, the threshold may be fixed (e.g., via the design of the prefetch table storage circuitry 201), the threshold may be a programmable parameter (e.g., via a programmable register), the threshold may be algorithmically determined (e.g., via the design of prefetch circuitry such as circuitry 107). For ease of explanation, the stream root detection threshold in the illustrated example 202 is 12 (e.g., the stream root detection threshold is met if the corresponding memory address region is subject to 12 or more memory accesses).

The example stream distance indicators 205 may have more than two stream distance indicating states. The illustrated example includes indicators 205 having four states. For instance, a first state may indicate that the entry is not part of a stream other than as a root entry. For example, the first state may represent a 0/null value. Accordingly, a stream distance indicator 205 in the 0 state may indicate that the entry is a root entry (hence, its distance to the root entry is 0) and/or that the entry is not associated with any stream (hence, there is no distance to a root entry). Continuing the example, a second state may indicate that the entry is adjacent to a root entry (e.g., its distance to the root is 1), a third state may indicate that the entry is adjacent to an entry adjacent to a root entry (e.g., its distance to the root is 2), while a fourth state may indicate that there are two intervening entries between it and the root (e.g., its distance to the root is 3). Other implementations may include other states and/or the states may be indicative of the distance to a root in other manners. For example, the indicators 205 may generally have N states to indicate distances up to N−1 from a stream root. In these examples, the N states may be established in any suitable manner as discussed with respect to the threshold. In further implementations, the indicators 205 may indicate less specific distances to root entries. For instance, a first state may indicate a root entry or non-stream entry (e.g., a 0 distance), a second state may indicate a distance between 1 and J regions from the entry to the root, and a third state may indicate between J+1 and K regions away from the root (e.g. “zero”, “near”, “far” states). In such an example, the number of a regions to which different states correspond (e.g., J and K) may be established in various suitable manners as discussed herein.

The example table state illustrated in FIG. 2A will be described to illustrate aspect of an implementation of prefetch table storage circuitry 201. As a shorthand for ease of explanation, the memory address regions corresponding to particular entries may be referenced by their entry labels. For instance, the term “a memory access for entry 0000” refers to a memory access to data having an address within the corresponding memory region 0000-0016. Likewise, the term “entry X is n regions away from entry Y” refers to the memory region corresponding to address X is n memory regions from the memory region corresponding to address Y Similarly, the term “entry X is adjacent to entry Y” refers to memory region X being adjacent to memory region Y (e.g., addresses X immediately precede or follow memory region Y).

Here, entry 0000 comprises an access counter 204 indicative of 13 accesses to the memory address region (e.g., 13 tracked demand access to cache-lines addressed between 0000 and 0016 have occurred since entry 0000 was allocated) and a stream distance indicator indicative of 0 distance to a root memory region. Accordingly, entry 0000 may serve as a root entry for neighboring entries. As discussed above, in some implementations, these access may have been to any cache-lines within the region, while in other implementations, these accesses may have been to unique cache-lines within the region.

Entry 0080 (e.g., cache-lines 0080-0095) has an access counter 204 indicative of 8 memory accesses and a stream distance indicator in the 2 state. Accordingly, entry 0080 is two regions away from its root entry, corresponding to memory address region 0112, which may have an entry in an unillustrated portion of the table 202 or may have been removed (e.g., evicted/retired) from the table 202. Accordingly memory address region 0080 is part of a stream with memory address region 0112-0127.

Entry 0064 has an access counter 204 indicative of 6 memory accesses and a stream distance indicator 205 in the 1 state, indicating that an adjacent entry is a root entry. In some implementations, a first stream distance indicator 205 may indicate a stream distance based on the access count indicator 204 of a root entry. In particular, the stream distance indicator 205 may be based on an adjacent entry having met the stream detection threshold. For example, entry 0064 may have a stream distance indicator 205 in the 1 state based on entry 0000 having an access counter 204 meeting the stream detection threshold. Accordingly, entry 0064 is part of a stream with entry 0000 as the root entry (e.g., memory address region 0064-0079 is part of a stream starting with memory address region 0000-0015).

Entry 0032 has an access counter 204 indicative of 1 memory access and a stream distance indicator in the 2 state, indicating that it is adjacent to a root-adjacent entry (e.g., its corresponding memory region is 2 regions from the root memory region). In some implementations, a stream distance indicator may be based on a second stream distance indicated by a second stream distance indicator of a second entry corresponding to an adjacent memory region. Entry 0032, for example, may have a stream distance indicator 205 based on the stream distance indicator 205 of entry 0064. For instance, prefetch table storage circuitry 201 may set the stream distance indicator 205 by incrementing a non-zero stream distance indicator 205 of an adjacent entry.

Entry 0064 has an access counter 204 indicative of 10 memory access and a stream distance indicator in the 3 state. In some implementations, in response to multiple adjacent entries having non-zero stream distance indicators, the prefetch table storage circuitry 201 may set an entry's stream distance indicator based on the minimum valued stream distance. For instance, in FIG. 2A, entry 0064 is adjacent to entry 0080 and to entry 0048, both of which have non-zero stream distance indicators. Thus, entry 0064 has a stream distance indicator 205 based on the entry having the lower stream distance indicator, entry 0080. In particular, in this example, entry 0064 has a stream distance indicator 205 that is incremented over entry 0080's stream distance indicator 205. Accordingly, the memory address region 0064-0079 is part of the stream including memory address regions 0080-0095 (entry 0080), 0096-00111, and 0112-0127, as the root memory address region.

Entry 0048 has an access counter 204 indicative of one memory access and a stream distance indicator 205 in the 3 state. Entry 0048 has two adjacent entries, entry 0032 and entry 0064, with entry 0032 having a lower distance indicator. Therefore, the stream distance indicator 205 of entry 0048 is incremented over that of entry 0032. Accordingly, the memory address region 0048-0063 is part of the stream including 0032-0047, 0064-0079, and 0000-0015 as the root memory address region.

FIG. 2B illustrates a further example state of table 202 representing the example scenario of FIG. 2A after a number of table updates in view of a number of memory accesses. For example, FIG. 2B may represent the state of table 202 following an initial allocation of entry 0128.

In FIG. 2B, entry 0128 has replaced entry 0000. For example, entry 0000 may have been evicted from the table to make room for entry 0128, entry 0000 may have been retired from the table (e.g., based on having met a retirement access count threshold), and/or otherwise removed. Here, entry 0128 has an access counter 204 indicating 1 memory access (e.g., a demand load that triggered allocation of entry 0128), and a stream distance indicator of 0. In some implementations, the stream distance indicators 205 may have states indicative of a maximum value. In these examples, prefetch table storage circuitry 201 may set the stream distance indicators 205 based on adjacent entries having distance indicators indicative of distance less than the maximum value. For instance, when entry 0128 was allocated, the prefetch table 202 may have included an entry for region 0144-0159 that had a stream distance indicator in the maximum value state (e.g., the 3 state in the illustrated example).

In FIG. 2B, entry 0080 has an access count indicator indicative of 12 memory accesses (e.g., memory address region 0080-0095 has been accessed 4 additional times since FIG. 2A). In some implementations, the prefetch table storage circuitry 201 may forgo updating the stream distance indicator 205 of an entry 206 once its access count meets the stream detection threshold. For example, entry 0080 may retain its stream distance indicator 205 in the 2 state after meeting the stream detection threshold. For instance, a non-zero stream distance indicator may be used by prefetch request generation circuitry to generate stream-type prefetch requests. Maintaining the stream distance indicator after meeting the stream detection threshold may enable the continued generation of such requests. In further implementations, the prefetch table storage circuitry 201 may continue to update the stream distance indicator 205 of an entry 206 after its access count meets the threshold. For instance, if entry 0096 reaches the threshold, then entry 0080 might have its distance set to 1. Accordingly, in various implementations, a table entry 206 may be both a root entry and a stream entry.

Returning to FIG. 2B, entry 0064 has an access count indicator 204 indicative of 7 memory accesses and a stream distance indicator 205 in the 1 state. In some implementations, an entry 206 may retain its stream distance indicator state when after its adjacent entry is removed from the table. For instance, entry 0064 retains the 1 state despite entry 0000 having been removed from the table. For example, as discussed above, sufficiently out-of-order program execution may result in regions that may disrupt streaming data access patterns. However, prefetch table storage circuitry 201 may mitigate this via the state retention. For instance, in FIG. 2B, entries 0064 and 0128 retain their states that resulted from having been in a stream with root entry 0000. Accordingly, memory address regions 0064-0079 and 0128-0143 maintain their status as stream regions despite out-of-order execution removing their root entry.

Continuing with FIG. 2B, entry 0128 has an access count indicator 204 indicative of 1 memory access and a stream distance indicator 205 in the 2 state. For example, entry 0128 may be in the same state as in FIG. 2A because of a lack of memory accesses to region 0128-0143.

Entry 0048 has an access count indicator 204 indicative of 3 memory accesses and a stream distance indicator 205 in the 2 state. Compared to FIG. 2A, entry 0048 has had its stream distance indicator 205 reduced. For example, this might have occurred if entry 0064 had its stream distance indicator in the 1 state before being removed from the table. In some implementations, a stream distance indicator may be maintained in a pre-existing state if setting the state based on adjacent entry would increase its stream distance indicator value. For example, the stream distance indicator may be set based on an adjacent stream distance indicator being less than its current stream distance indicator. For instance, in the illustrated example, entry 0128 is adjacent to entry 0048 and entry 0064 is no longer in the table. Accordingly, entry 0128 is the only adjacent entry to entry 0048 having a non-zero stream distance indicator. However, entry 0048 may retain the 2 state because basing its state on entry 0048 would result in a 3 state.

Entry 0096 has been added to the table 202 and includes an access count indicator 204 indicative of seven memory accesses and a stream distance indicator 205 in the 1 state. In some implementations, when an adjacent entry includes both an access count greater than the stream detection threshold and a stream distance indicator less than a maximum value, the prefetch table storage circuitry 201 may set an entry's stream distance indicator based on the adjacent access count rather than the adjacent stream distance indicator. Consequently, the prefetch table storage circuitry 201 may set an entry's stream distance indicator based an adjacent entry having a non-zero stream distance indicator and an access count less than the stream detection threshold. For instance, in FIG. 2B, entry 0096 is adjacent to entry 0080 and has both an access count meeting the threshold (12) and a non-zero stream distance indicator (state 2). Accordingly, entry 0096 has a stream distance indicator in state 1 based on its adjacent entry 0080 having met the access count indicator threshold. Thus, in implementations where an entry retains its stream distance indicator after having met the access count threshold, the retained stream distance indicator does not adversely impact stream distance detection (e.g., entry 0080's status as a root entry results in adjacent entries having distance indicators in the 1 state rather than the 3 state).

As indicated above, streaming data patterns may have directionality. For example, one streaming pattern might comprise a sequence of demand loads with decreasing/descending addresses while another might comprise a sequence of demand loads with increasing/ascending addresses. However, OoO execution may disrupt such a sequence, for example, by issuing demand loads for higher-addressed cache-lines before those for lower-addressed cache-line despite an increasing stream direction. In some implementations, a prefetch table may include stream direction indicators. In such implementations, prefetch table storage circuitry may base stream distance indicators on such stream direction indicators.

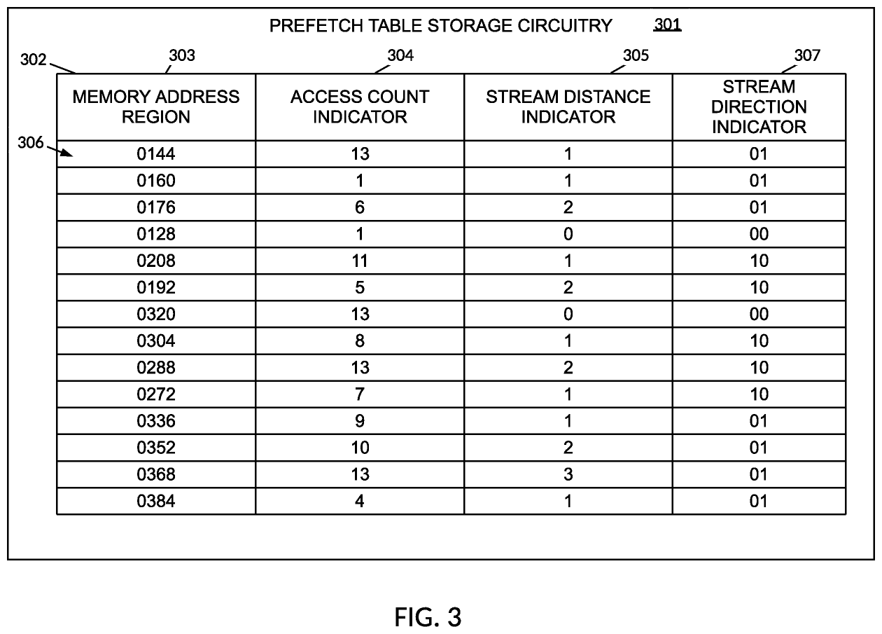

FIG. 3 illustrates example prefetch table storage circuitry 301 to store a prefetch table 302 having entries 306 comprising stream direction indicators 307. For example, prefetch table storage circuitry 301 may be an implementation of prefetch table storage circuitry 108 of FIG. 1 and/or prefetch table storage circuitry 201 of FIGS. 2A-B.

In this example, a prefetch table 302 may comprise entries 306 corresponding to memory address regions 303 and comprising access count indicators 304, stream distance indicators 305, and stream direction indicators 307. Unless otherwise indicated, the memory address regions 303, access count indicators 304, and stream distance indicators 305 may be as described with respect to memory address regions 203, access count indicators 204, and stream distance indicators 205 of FIGS. 2A-B, respectively.

The example prefetch table 302 further comprises stream direction indicators 307, where a given entry's stream direction indicator 307 is indicative of a memory address direction from a root entry to the given entry. In some implementations, the stream direction indicators 307 may have a first state indicating an ascending stream direction and a second state indicating a descending stream direction. In further implementations, the stream direction indicators 307 may have additional states, such as a third state indicating that a stream direction has not been established and/or a fourth state indicating that a stream is bi-directional (e.g., ascending and descending). For instance, in the illustrated example, the stream direction indicators 307 are represented by a pair of bits, where each bit represents a logical value indicating that the stream is proceeding in a corresponding direction. As illustrated, the leftmost bit indicates whether the stream is descending or not and the rightmost bit indicates whether the stream is ascending (e.g., state 01 indicates an ascending stream, state 10 indicates a descending stream, and state 00 indicates that a direction has not been established.

In some implementations, the stream direction indicators 307 may be used by the prefetch table storage circuitry 301 when allocating or updating table entries 306. An example scenario illustrating example uses of a stream direction indicator will be described with respect to the table state illustrated in FIG. 3.

Entry 0144 has an access count indicator 304 indicative of 13 memory accesses, a stream distance indicator 305 in the 1 state and a stream direction indicator in the 01 state. Accordingly, entry 0144 comprises an entry having met the stream detection threshold (12 in this example) where the distance indicator state 305 is indicative of a prior adjacent root entry and the stream direction indicator 307 is indicative of an ascending data stream. Thus, an entry corresponding to memory address region 0128-0143 was the prior root note to entry 0144 (e.g., the direction from region 0128-0035 to 0144-0159 is ascending).

In some implementations, an entry's stream direction indicator may be set to match its preceding adjacent entry. For instance, entry 0160 has an access count indicator 304 indicative of 1 memory access, a stream distance indicator 305 in state 1 and a stream direction indicator 307 in state 01. Here, entry 0160 is adjacent to entry 0144 in the direction indicated by entry 0144's indicator. Accordingly, entry 0160 may have its stream distance indicator 307 set to match its root entry 0160.

Similarly, entry 0176 has an access count indicator 304 indicative of 6 memory accesses, a stream distance indicator 305 in the 2 state, and a stream direction indicator in the 01 state. For example, at its latest update, entry 0176 is adjacent to entry 0160 in the direction matching entry 0160's direction indicator. Accordingly, entry 0176's stream distance indicator 305 is incremented over entry 0160's distance indicator and its stream direction indicator is set to match that of entry 0160.

In some implementations, if an entry's address does not match the direction of any entry, then the entry may be set to have a zero distance indicator and a default direction indicator state. In the illustrated example, entry 0128 has an access count indicator 304 indicative of one memory access, a stream distance indicator 305 in the zero state, and a stream direction indicator 307 in the default 00 state. As illustrated, entry 0128 is adjacent to entry 0144, which has met the stream detection threshold and qualifies as a potential root entry. However, entry 0128 corresponds to a lower memory address region than that of entry 0144 and entry 0144's direction indicator 307 indicates a positive/ascending direction. Accordingly, the direction from entry 0144 to entry 0128 does not match entry 0144's direction indicator. Thus, entry 0144 is not a qualifying root node for entry 0128. Accordingly, entry 0128 is not part of a stream and its distance indicator is set to its default 0 state and its direction indicator is likewise set to its default 00 state.

In some implementations, when there are multiple potentially qualifying adjacent entries, an entry's distance indicator may be set based on whichever adjacency would result in a lower distance indicator. For example, entry 0192 is adjacent to entry 0208 and its address region matches the descending direction indicated by entry 0208's distance indicator state 10. Likewise, entry 0192 is adjacent to entry 0176 and matches entry 0176's distance indicator state 01. However, entry 0208 has a lower stream distance indicator than entry 0176. Accordingly, prefetch table storage circuitry 301 may select entry 0208 as entry 0192's adjacent entry, such that entry 0192's stream distance indicator 307 is incremented over entry 0208's stream distance indicator 307 and entry 0192's stream direction indicator 307 is set to match entry 0208's.

In some implementations, an entry's stream direction indicator 307 may remain constant once it is set. This may prevent entry's from being misidentified with the wrong stream in the presence of table updates resulting from OoO processing. For example, in the scenario illustrated in FIG. 3, entry 0192 would retain its direction indicator 10 even if entry 0208 is removed from the table. Accordingly, once set, entry 0176 would no longer qualify as a potential adjacent entry (since it is in the wrong direction from entry 0192's retained direction indicator) and will retain its state as a member of a descending data stream.

As indicated above, a stream may have multiple root entries. Accordingly, a stream entry's distance indicator may indicate its distance to its nearest root entry. Additionally, as discussed above, an entry's stream direction indicator 307 may be set when entry's stream distance indicator is first set. Accordingly, a qualifying root entry may have a 00 direction indicator. In this case, a stream may have ascending portions and descending portions (e.g., a new entry below the root entry will set its direction to 10, while a new entry above the root entry will set its direction to 01). Entries 0272-0384 illustrate an example stream that illustrate these and other aspects as described herein.

In this example, entry 0320 has met its stream detection threshold and is thus qualified as a root entry. However, entry 0320 was not part of an earlier stream when it met the threshold (e.g., its stream distance indicator is in the 0 state) so its direction bits are in the default 00 state. Root entry 0320 has two adjacent stream entries: entry 0304 in the descending direction and entry 0336 in the ascending direction.

Beginning with the descending stream portion, entry 0304 has a stream distance indicator 305 in the 1 state because it is directly adjacent to root entry 0320. Since root entry 0320's direction indicator is in the default state (e.g., it does not indicate a direction), entry 0304 trivially matches entry 0320's direction indicator. Entry 0304 corresponds to a lower address region than entry 0320, so prefetch table storage circuitry sets its stream direction indicator 307 to the descending state (10).

Entry 0288 has met the stream detection threshold with 13 accesses, and is therefore a qualifying root node. However, prior to meeting the threshold, entry 0288 had its distance indicator set to 2 and its direction indictor set to descending (10) based on its adjacent entry 0304.

Entry 0272 is adjacent to entry 0288 and corresponds to a lower memory region. Accordingly, because entry 0288 is a qualifying root entry in the correct direction, entry 0272's stream distance indicator 305 is set to the 1 state and its direction indicator is set to the descending state. As an example scenario, entry 0272 may have had its distance indicator set to 3 and its direction indicator set to 10 prior to entry 0288 meeting the stream detection threshold. In this scenario, entry 0272 would have had its distance indicator set to 1 after entry 0288 reached the threshold and would retain the descending direction indicator. (As discussed above, in some implementations a direction indicator does not change once it is set the first time.)

Proceeding with the ascending stream portion, entry 0336 is adjacent to entry 0320 and its corresponding memory region is in the ascending direction. Like entry 0304, entry 0336 trivially matches entry 0320's direction indicator. Accordingly, entry 0336's stream distance indicator 305 is set the 1 state. Being in the ascending direction from entry 0320, entry 0336's stream direction indicator 307 is set to the ascending state (01).

Entry 0352 is adjacent to entry 0336 and its direction matches entry 0336's direction indicator. Accordingly, entry 0336 is a qualifying adjacent entry and entry 0352's distance indicator is set to the 2 state (e.g., incremented over entry 0336's 1 state) and its direction indicator is set to the ascending state (01) to match entry 0336's.

Entry 0368 is adjacent to entry 0352 and its direction from the entry matches entry 0352's direction indicator. Accordingly, entry 0352 is a qualifying adjacent entry and entry 088's distance indicator is set to the 3 state (e.g., incremented over entry 0352's 2 state) and its direction indicator is set to the ascending state (01) to match entry 0352's. Additionally, entry 0368's access count 304 has met the stream detection threshold, so it qualifies as a root entry.

Finally, entry 0384 is adjacent entry 0368 and matches entry 0368's ascending direction indicator. Entry 0368 is a qualifying adjacent entry and is a qualifying root node. Accordingly, entry 0384's stream distance indicator is set to the 1 state and its direction indicator is set to the ascending state (01).

In summary, the example stream comprises: {0272(S,D); 0288 (S,R,D); 0304 (S,R,D), 0320 (R); 0336 (S, A); 0352 (S, A); 0368 (S,R,A); 0384 (S, A)}, where S refers to an entry being a stream entry (e.g., having a non-zero stream distance indicator), R refers to an entry being a root entry (e.g., having an access count meeting the threshold), D refers to an entry having a descending direction, and A refers to an entry having an ascending direction.

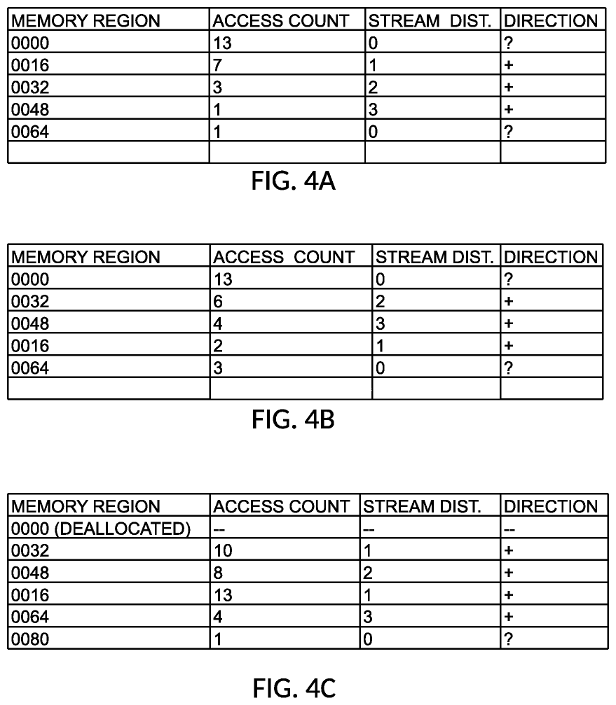

FIGS. 4A-F show various prefetch tables further illustrating various aspects discussed herein. For example, the tables may illustrate example prefetch table states of a prefetch table including direction indicators, such as prefetch table 302 stored by prefetch table storage circuitry 301 of FIG. 3. For ease of explanation, the example tables have 6 maximum entries, the memory regions are 16 cache-lines long, the stream detection threshold is 12, the maximum stream distance is 3, and the tables are sorted by increasing memory address. Of course, implementations may employ various different parameters and entries may arranged and/or accessed in any order, as discussed above.

FIG. 4A is an example prefetch table state including a stream comprising four entries. In this example, entry 0000 had been accessed 13 times by the time entry 0016 was added. As the initial entry, its direction is in the unset (?) state. When entry 0016 was allocated, being adjacent to a qualifying root node, its stream distance was set to 1. Additionally, entry 0016 corresponds to a higher memory region than entry 0000, so its direction was set to the ascending state (+). When entry 0032 was allocated, it was adjacent to entry 0016 in the ascending direction. Because entry 0016 has not met the stream detection threshold, it is not a qualifying root entry. Accordingly, entry 0032 has its distance set to 2 by incrementing 0016's distance of 1 and its direction set to match that of entry 0016 (+). When entry 0048 was added, it was adjacent to entry 0032 in the ascending direction, so its direction is set to the ascending state. Since entry 0032 had not met the stream detection threshold, entry 0048's stream distance indicator was set to 3 (the maximum value in this example). Finally, when entry 0064 was added, it was not added to the stream with entries 0000-0048 because its adjacent entry had not met the root threshold and had met the maximum distance value. Accordingly, entry 0064's distance was set to 0 and its direction was left in the unset state (?).

FIG. 4B is an example prefetch table state illustrating an aspect of the described technology's resilience to out-of-order execution. In this example, entry 0000 had been accessed 13 times by the time entry 0016 was added. As the initial entry, its direction is in the unset (?) state. After entry 0000 met the threshold, entries 0032 and 0048 were allocated. Initially, the entries were not adjacent to any qualifying entry so their distance and direction were 0 and (?). Later, entry 0016 was allocated and being adjacent to entry 0000, its stream distance was set to 1 and its direction was set to ascending. After entry 0016 was allocated, entry 0032 was updated (e.g., responsive to a new cache-line in region 0032 being accessed). At the update, entry 0032 was adjacent to entry 0016 in the ascending direction. Accordingly, its stream distance indicator was set to 2 and its direction set to (+). Likewise, entry 0048 was updated after entry 0032 was updated. At this update, entry 0048 was adjacent to entry 0032 in the ascending direction. Accordingly, its stream distance indicator was set to 3 and its direction set to (+). Finally, after entry 0016 was allocated, entry 0064 was allocated. Although entry 0064 is adjacent to entry 0048, entry 0048's distance was in the maximum state. Accordingly, entry 0064 had its distance indicator set to 0 and its direction left in the in (?) state. In summary, although out-of-order execution resulted in entries 0032 and 0048 being allocated before entry 0016, entries 0032 and 0048 correctly became part of the stream upon being updated.

FIG. 4C is an example prefetch table state illustrating an aspect of the described technology's resilience to entry deallocation. In particular, FIG. 4C represents a later table state following the state in FIG. 4B. Here, entry 0000 has been deallocated (it is left in the table for explanatory purposes). However, entry 0016 reached the stream detection threshold prior to the latest updates to entries 0032 and 0048 and now qualifies as a root entry. At an update, entry 0032 had its stream distance set to 1 because it was adjacent a qualifying root entry, while its direction remained unchanged. Similarly, entry 0048 had its stream distance set to 2 because of its adjacency to entry 0032. Thus, entry 0048 was no longer in the maximum distance state, so when entry 0064 was updated, its distance was set to 3 and its direction set to (+). Finally, entry 0080 was allocated and because its adjacent entry was in the maximum distance state, its distance was set to 0 and its direction to (?). In summary, after deallocation of entry 0000, entries 0016-0048 remained in the stream and entry 0064 was added, so the stream continued to propagate after the deallocation the initial root entry.

FIG. 4D is an example prefetch table state illustrating a further aspect of the described technology's resilience to out of order execution and/or entry deallocation. In particular, FIG. 4D represents a later table state following that of FIG. 4C. Here, entries 0032 and the first entry 0048 have been deallocated, while another entry 0048 has been reallocated after an access to entry 0080. In this example, entry 0016 remains a qualifying root entry and retains its stream distance indicator and its direction state. Entry 0064 has met the stream detection threshold and retains its stream distance indicator in the 2 state and its direction indicator in the (+) state. Accordingly, when updated, entry 0080 was adjacent a qualifying root entry and its stream distance indicator was set to 1. Finally, entry 0048 was reallocated as a new entry. Although entry 0064 corresponds to an adjacent memory region, its direction indicator does not match the direction from address 0064 to address 0048. Accordingly, entry 0048 was reallocated with 0 stream distance indicator and (?) stream direction indicator. In summary, despite multiple deallocations and reallocations, the stream may continue to propagate in an ascending direction from entry 0080.

FIG. 4E is an example prefetch table state illustrating an aspect of the described technology's resilience to colliding stream data access patterns. Notably, FIG. 4E represents a different scenario than that of FIGS. 2B-D. In this example, both entries 0000 and 0064 have been allocated and meet the access count threshold. Not being adjacent to any qualifying entries, their stream distance indicator and direction indicators were left in the 0 and (?) states. When entry 0016 was allocated, it was adjacent to entry 0000 in the ascending direction. Accordingly, its stream distance indicator was set to 1 and its stream direction indicator to the ascending (+) state. Similarly, when entry 0048 was allocated, it was adjacent to entry 0064 in the descending direction. Accordingly, its stream distance indicator was set to 1 and it stream direction indicator to the descending (−) state. Finally, when entry 0032 was added, it was adjacent to both entry 0048 and entry 0016, both of which had equal non-zero stream distance indicators. In this example, if an entry has two qualifying adjacent entries that have equal distance indicators, its direction is set to the ascending state (+). Accordingly, entry 0016 serves as entry 0032's adjacent entry, and its distance is set to 2 and its direction is set to (+). For instance, this default may reflect a general tendency for in-order memory accesses to have increasing addresses. In other implementations, an entry might be set to the descending state (−) in a tied situation, the direction indicator may be left unset, the default direction may be a configurable parameter, and/or the like.

FIG. 4F is an example prefetch table state illustrating a further aspect of the described technology's resilience to out of order execution. Similarly, FIG. 4F illustrates a separate scenario from FIGS. 4A-4E. In this example, entry 0016 was initially allocated, so its stream distance indicator was set to 0 and its direction is in the (?) state. Afterward, entry 000 was allocated with its stream distance set to 1 and its direction set to (−) because of its descending adjacency to entry 0016. Similarly, entry 0032 was allocated with its stream distance set to 1 and its direction set to (+) because of its ascending adjacency to entry 0016. Afterward, entry 0048 was allocated with its stream distance set to 2 and its direction set to (+) because of its ascending adjacency to entry 0032. In summary, the system may recover from an erroneous direction detection and the example stream may continue to propagate in the ascending direction despite the allocation of entry 0000 with a descending direction.

FIG. 5 illustrates an example method of operation of a data processing apparatus in accordance with an implementation. In some implementations, the illustrated method may be performed by a data processing apparatus as described with respect to FIG. 1. For example, the illustrated method may be performed by prefetch circuitry including prefetch table storage circuitry such as prefetch circuitry 107 and prefetch table storage circuitry 108 of FIG. 1. In particular implementations, the method may be preformed by prefetch table storage circuitry such as prefetch table storage circuitry 201 of FIGS. 2A-B and/or prefetch table storage circuitry 301 of FIG. 3.

In some implementations, the method may include operation 501, which includes storing a prefetch table. For example, the prefetch table may comprise entries corresponding to memory address regions and comprising access count indicators indicative of numbers of accesses to corresponding memory address regions and stream distance indicators having more than two stream distance indicating states. In some implementations, a distance indicator may be indicative of a stream distance between a memory address region corresponding to the entry and a root memory address region. Additionally, the root memory address region may correspond to a root entry of the prefetch table having a access count indicator indicating a number of accesses meeting a stream root detection threshold. For example, operation 501 may include storing a prefetch table such as prefetch table 202 of FIGS. 2A-B and/or prefetch table 302 of FIG. 3.

In some implementations, the method may include operation 502, which includes detecting an access to a first memory address region. For example, operation 502 may include detecting a demand memory access, such as a demand load operation issued by load/store circuitry such as load/store circuitry 103 of FIG. 1. For instance, the demand memory access may be for a unit of memory such as a cache line having an address falling within a particular memory address region.

In some implementations, the method may include operation 503, which includes setting a first stream distance indicator of a first prefetch table entry. For example, operation 503 may include setting the first stream distance indicator to indicate a first stream distance based on a second stream distance indicated by an adjacent table entry's stream distance indicator. For instance, operation 503 may comprise setting the first entry's distance indicator by incrementing the adjacent table entry's stream distance indicator. In further implementations, operation 503 may include setting stream distance indicators and/or stream direction indicators based on various criteria as described herein. For example, operation 503 may include setting an entry's stream distance indicator based on an adjacent entry having met a stream detection threshold. As another example, operation 503 may include setting an entry's stream distance indicator based on an adjacent entry's stream distance indicator being less than a maximum value. As a further example, operation 53 may include setting an entry's stream distance indicator based on an adjacent entry having a matching stream direction indictor.

Concepts described herein may be embodied in an apparatus comprising execution circuitry having one or more vector processing units for performing vector operations on vectors comprising multiple data elements. Execution circuitry having X vector processing units each configured to perform vector operations on Y bit wide vectors, with the respective vector processing units operable in parallel, may be said to have an XxY bit vector datapath. In some embodiments, the execution circuitry is provided having six or more vector processing units. In some embodiments, the execution circuitry is provided having five or fewer vector processing units. In some embodiments, the execution circuitry is provided having two vector processing units (and no more). In some embodiments, the one or more vector processing units are configured to perform vector operations on 128-bit wide vectors. In some embodiments, the execution circuitry has a 2×128 bit vector datapath. Alternatively, in some embodiments the execution circuitry has a 6×128 bit vector datapath.

Concepts described herein may be embodied in an apparatus comprising a level one data (L1 D) cache. The L1 D cache is a private cache associated with a given processing element (e.g. a central processing unit (CPU) or graphics processing element (GPU)). In a cache hierarchy of multiple caches capable of caching data accessible by load/store operations processed by the given processing element, the L1 D cache is a level of cache in the hierarchy which is faster to access than a level two (L2) cache. In some embodiments, the L1 data cache is the fastest to access is the hierarchy, although even faster to access caches, for example, level zero (L0) caches may also be provided. If a load/store operation hits in the L1 D cache, it can be serviced with lower latency than if it misses in the L1 D cache and is serviced based on data in a subsequent level of cache or in memory. In some embodiments, the L1 D cache comprises storage capacity of less than 96 KB, in one example the L1 D cache is a 64 KB cache. In some embodiments, the L1 D cache comprises storage capacity of greater than or equal to 96 KB, in one example the L1D cache is a 128 KB cache.

Concepts described herein may be embodied in an apparatus comprising a level two (L2) cache. The L2 cache for a given processing element is a level of cache in the cache hierarchy that, among caches capable of holding data accessible to load/store operations, is next fastest to access after the L1 D cache. The L2 cache can be looked up in response to a load/store operation missing in the L1 D cache or an instruction fetch missing in an L1 instruction cache. In some embodiments, the L2 cache comprises storage capacity of less than 1536 KB (1.5 MB), in one example the L2 cache is a 1024 KB (1 MB) cache. In some embodiments, the L2 cache comprises storage capacity greater than or equal to 1536 KB and less than 2560 KB (2.5 MB), in one example the L2 cache is a 2048 KB (2 MB) cache. In some embodiments, the L2 cache comprises storage capacity greater than or equal to 2560 KB, in one example the L2 cache is a 3072 KB (3 MB) cache. In some embodiments, the L2 cache has a larger storage capacity than the L1 D cache.

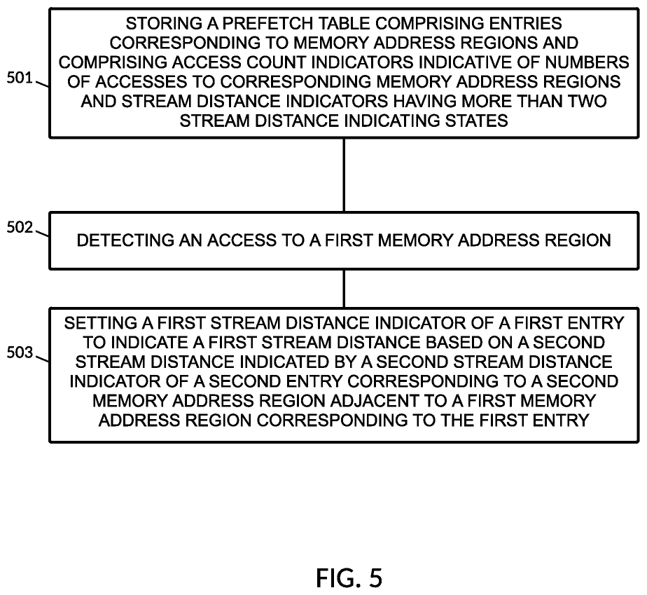

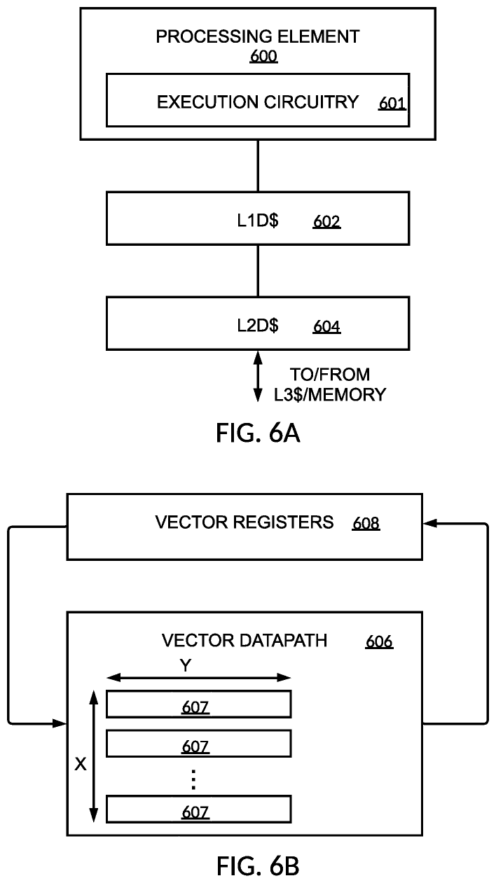

FIG. 6A illustrates an example of an apparatus comprising a processing element 600 (e.g. a CPU or GPU) comprising execution circuitry 601 for executing processing operations in response to decoded program instructions. The processing element 600 has access to a L1 D cache 602 and a L2 cache 604, which are part of a cache hierarchy of multiple caches for caching data from memory that is accessible by the processing element 600 in response to load/store operations executed by the execution circuitry 601. For example, processing element 600 may comprise an implementation of a processing element 101, where execution circuitry 601 comprises an implementation of execution circuitry 102. Similarly, L1 D cache 602 may comprise an implementation of an L1 cache 104, L2 cache 604 may comprise an implementation of an L2 cache 105.

FIG. 6B illustrates an example of a vector datapath 606 that may be provided as part of the execution circuitry 601 of the processing element 600, and vector registers 608 for storing vector operands for processing by the vector datapath 606. Vector operands read from the vector registers 608 are processed by the vector datapath 606 to generate vector results which may be written back to the vector registers 608. The vector datapath 606 is an XxY bit vector datapath, comprising X vector processing units 607 each configured to perform vector operations on Y bit vectors. The vector registers 608 may be accessible as Z bit vector registers, where Z can be equal to Y or different to Y For a vector operation requiring a Z-bit vector operand where Z is greater than Y, the Z-bit vector operand can be processed using two or more vector processing units 607 operating in parallel on different portions of the Z-bit vector operand in the same cycle and/or using multiple passes through the vector datapath in two or more cycles. For vector operations requiring a Z-bit vector operand where Z is less than Y, a given vector processing unit 607 can process two or more vectors in parallel.

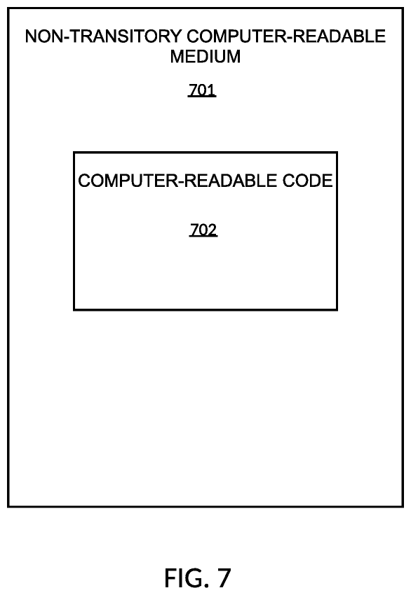

Concepts described herein may be embodied in computer-readable code for fabrication of an apparatus that embodies the described concepts. FIG. 7 illustrates an example non-transitory computer-readable storage medium 701 storing such computer-readable code 702. For example, the computer-readable code 702 can be used at one or more stages of a semiconductor design and fabrication process, including an electronic design automation (EDA) stage, to fabricate an integrated circuit comprising the apparatus embodying the concepts. The above computer-readable code 702 may additionally or alternatively enable the definition, modelling, simulation, verification and/or testing of an apparatus embodying the concepts described herein.

For example, the computer-readable code 702 for fabrication of an apparatus embodying the concepts described herein can be embodied in code 702 defining a hardware description language (HDL) representation of the concepts. For example, the code 702 may define a register-transfer-level (RTL) abstraction of one or more logic circuits for defining an apparatus embodying the concepts. The code 702 may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code 702 may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code 702 may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code 702 a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code 702 may comprise a mix of code 702 representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code 702 defining instructions which are to be executed by the defined apparatus once fabricated.

Such computer-readable code 702 can be disposed in any known transitory computer-readable medium (such as wired or wireless transmission of code 702 over a network) or non-transitory computer-readable medium 701 such as semiconductor, magnetic disk, or optical disc. An integrated circuit fabricated using the computer-readable code 702 may comprise components such as one or more of a central processing unit, graphics processing unit, neural processing unit, digital signal processor or other components that individually or collectively embody the concept.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Some configurations of the present techniques are described by the following numbered clauses:

Clause 1. An apparatus, comprising:
prefetch table storage circuitry to store a prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

Clause 2. The apparatus of clause 1, wherein a first stream distance indicator of a first entry is indicative of a number of contiguous memory regions from a first root memory address region to a first memory address region corresponding to the first entry.

Clause 3. The apparatus of clause any preceding clause, wherein a first access count indicator of a first entry is indicative of a number of unique accesses to cache-lines having addresses falling within a first memory address region corresponding to the first entry.

Clause 4. The apparatus of any preceding clause, wherein the first stream distance indicator is to indicate the first stream distance of the first entry based on a second stream distance indicated by a second stream distance indicator of a second entry corresponding to a second memory address region adjacent to the first memory address region corresponding to the first entry.

Clause 5. The apparatus of any preceding clause, wherein the first stream distance indicator is to indicate the first stream distance based on an access count indicated by a second access count indicator of the second entry not meeting the stream root detection threshold.

Clause 6. The apparatus of any preceding clause, wherein the first stream distance indicator is to indicate the first stream distance based on the second stream distance indicator indicating a second stream distance less than a maximum value.

Clause 7. The apparatus of any preceding clause, wherein the first stream distance indicator is to indicate the first stream distance based on the first stream distance being less than a preexisting distance indicated by a preexisting first stream distance indicator of the first entry.

Clause 8. The apparatus of any preceding clause, wherein a third stream distance indicator is to indicate a stream distance of a third entry based on the access count indicator of a first root entry meeting the stream detection threshold, wherein a first root memory address region corresponding to the first root entry is adjacent to a third memory address region corresponding to the third entry.

Clause 9. The apparatus of any preceding clause, wherein a fourth entry comprises a fourth access count indicator meeting the stream root detection threshold and a fourth stream distance indicator to indicate a previous stream distance of the fourth entry to a second root entry prior to meeting the stream root detection threshold.

Clause 10. The apparatus of any preceding clause, wherein the stream distance indicator of the first root entry comprises a stream distance indicating state indicative of zero stream distance.

Clause 11. The apparatus of any preceding clause, wherein entries of the prefetch table comprise stream direction indicators, and a first stream direction indicator of the first entry is indicative of a first stream direction from the first root memory address region of the first root entry to the first memory address region corresponding to the first entry.

Clause 12. The apparatus of any preceding clause, wherein the first stream distance indicator of the first entry is to indicate the first stream distance based on a fifth stream distance indicated by a fifth stream distance indicator and a fifth stream direction indicator of a fifth entry corresponding to a fifth memory address region adjacent to the first memory address region corresponding to the first entry.

Clause 13. The apparatus of any preceding clause, wherein:
a sixth entry of the prefetch table comprises a sixth stream direction indicator indicative of a different stream direction than the second stream direction indicator and a sixth stream distance indicator indicative of a sixth stream distance from a sixth memory address region to a second root memory address region of a second root entry, the sixth memory address region being adjacent to the first memory address region; and
the first stream distance indicator of the first entry is based on the second stream distance being less than the sixth stream distance.

Clause 14. The apparatus of any preceding clause, further comprising: prefetch generation circuitry coupled to the prefetch control circuitry to initiate a prefetch operation associated with a first memory address region based on a stream distance value of a first entry corresponding to the first memory address region.

Clause 15. The apparatus of any preceding clause, further comprising: execution circuitry comprising a 6×128 bit vector datapath.

Clause 16. A non-transitory computer-readable medium to store computer-readable code for fabrication of the apparatus of any preceding clause.

Clause 17. A non-transitory computer-readable medium storing computer-readable code for the fabrication of an apparatus comprising:
prefetch table storage circuitry to store a prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

Clause 18. The non-transitory computer-readable medium of clause 17, wherein a first stream distance indicator is to indicate a first stream distance of a first entry based on a second stream distance indicated by a second stream distance indicator of a second entry corresponding to a second memory address region adjacent to a first memory address region corresponding to the first entry.

Clause 19. The non-transitory computer-readable medium of any of clauses 17-18, wherein the first stream distance indicator is to indicate the first stream distance based on an access count indicated by a second access count indicator of the second entry not meeting the stream root detection threshold.

Clause 20. The non-transitory computer-readable medium of any of clauses 17-19, wherein entries of the prefetch table comprise stream direction indicators, and a first stream direction indicator of the first entry is indicative of a first stream direction from the first root memory address region of the first root entry to the first memory address region corresponding to the first entry.

Clause 21. The non-transitory computer-readable medium of any of clauses 17-20, wherein the first stream distance indicator of the first entry is to indicate the first stream distance based on the second stream distance indicated by the second stream distance indicator and a second stream direction indicator of the second entry corresponding to the second memory address region adjacent to the first memory address region corresponding to the first entry.

Clause 22. A method, comprising:
storing a prefetch table, the prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

1. An apparatus, comprising:
prefetch table storage circuitry to store a prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

2. The apparatus of claim 1, wherein a first stream distance indicator of a first entry is indicative of a number of contiguous memory regions from a first root memory address region to a first memory address region corresponding to the first entry.

3. The apparatus of claim 1, wherein a first access count indicator of a first entry is indicative of a number of unique accesses to cache-lines having addresses falling within a first memory address region corresponding to the first entry.

4. The apparatus of claim 1, wherein a first stream distance indicator is to indicate a first stream distance of a first entry based on a second stream distance indicated by a second stream distance indicator of a second entry corresponding to a second memory address region adjacent to a first memory address region corresponding to the first entry.

5. The apparatus of claim 4, wherein the first stream distance indicator is to indicate the first stream distance based on an access count indicated by a second access count indicator of the second entry not meeting the stream root detection threshold.

6. The apparatus of claim 4, wherein the first stream distance indicator is to indicate the first stream distance based on the second stream distance indicator indicating a second stream distance less than a maximum value.

7. The apparatus of claim 4, wherein the first stream distance indicator is to indicate the first stream distance based on the first stream distance being less than a preexisting distance indicated by a preexisting first stream distance indicator of the first entry.

8. The apparatus of claim 1, wherein a first stream distance indicator is to indicate a first stream distance of a first entry based on the access count indicator of a first root entry meeting the stream detection threshold, wherein a first root memory address region corresponding to the first root entry is adjacent to a first memory address region corresponding to the first entry.

9. The apparatus of claim 1, wherein a first entry comprises a first access count indicator meeting the stream root detection threshold and a first stream distance indicator to indicate a first stream distance of the first entry to a first root entry.

10. The apparatus of claim 1, wherein a stream distance indicator of a first root entry comprises a stream distance indicating state indicative of zero stream distance.

11. The apparatus of claim 1, wherein entries of the prefetch table comprise stream direction indicators, and a first stream direction indicator of a first entry is indicative of a first stream direction from a first root memory address region of a first root entry to a first memory address region corresponding to the first entry.

12. The apparatus of claim 11, wherein a first stream distance indicator of the first entry is to indicate a first stream distance based on a second stream distance indicated by a second stream distance indicator and a second stream direction indicator of a second entry, the second entry corresponding to a second memory address region adjacent to the first memory address region corresponding to the first entry.

13. The apparatus of claim 12, wherein:
a third entry of the prefetch table comprises a third stream direction indicator indicative of a different stream direction than the second stream direction indicator and a third stream distance indicator indicative of a third stream distance from a third memory address region to a second root memory address region of a second root entry, the third memory address region being adjacent to the first memory address region; and
the first stream distance indicator of the first entry is based on the second stream distance being less than the third stream distance.

14. The apparatus of claim 1, further comprising:
prefetch generation circuitry coupled to the prefetch control circuitry to initiate a prefetch operation associated with a first memory address region based on a stream distance value of a first entry corresponding to the first memory address region.

15. The apparatus of claim 1, further comprising:
execution circuitry comprising a 6×128 bit vector datapath.

16. A non-transitory computer-readable medium storing computer-readable code for the fabrication of an apparatus comprising:
prefetch table storage circuitry to store a prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.

17. The non-transitory computer-readable medium of claim 16, wherein a first stream distance indicator is to indicate a first stream distance of a first entry based on a second stream distance indicated by a second stream distance indicator of a second entry corresponding to a second memory address region adjacent to a first memory address region corresponding to the first entry.

18. The non-transitory computer-readable medium of claim 16, wherein entries of the prefetch table comprise stream direction indicators, and a first stream direction indicator of a first entry is indicative of a first stream direction from a first root memory address region of a first root entry to a first memory address region corresponding to the first entry.

19. The non-transitory computer-readable medium of claim 18, wherein a first stream distance indicator of the first entry is to indicate a first stream distance based on a second stream distance indicated by a second stream distance indicator and a second stream direction indicator of a second entry corresponding to a second memory address region adjacent to the first memory address region corresponding to the first entry.

20. A method, comprising:
storing a prefetch table, the prefetch table comprising entries corresponding to memory address regions and comprising access count indicators indicative of numbers of accesses to corresponding memory address regions and stream distance indicators having more than two stream distance indicating states,
wherein a respective distance indicator of a respective entry is indicative of a respective stream distance between a respective memory address region corresponding to the respective entry and a respective root memory address region, wherein the respective root memory address region corresponds to a respective root entry of the prefetch table having a respective access count indicator indicating a number of accesses meeting a stream root detection threshold.
